(19) United States
(12) Patent Application Publication
(10) Pub. No.: US 2025/0156729 A1
(43) Pub. Date: May 15, 2025

(54) DEVICE AND METHOD FOR EMBEDDING KNOWLEDGE GRAPH

(71) Applicant: ELECTRONICS AND TELECOMMUNICATIONS RESEARCH INSTITUTE, Daejeon (KR)

(72) Inventors: Chon Hee Lee, Daejeon (KR); Dong-oh Kang, Daejeon (KR)

(21) Appl. No.: 18/921,243

(22) Filed: Oct. 21, 2024

(30) Foreign Application Priority Data
Nov. 15, 2023 (KR) 10-2023-0157817

(51) Int. Cl. G06N 3/0985; G06N 3/042; G06N 3/0495

(52) U.S. Cl. CPC G06N 3/0985; G06N 3/042; G06N 3/0495

(57) ABSTRACT

Provided are a device and method for embedding a knowledge graph. The device includes an acquisition module configured to acquire a knowledge graph embedding model and a tuning module configured to generate a low-dimensional embedding model by performing hyperparameter tuning on the acquired knowledge graph embedding model on the basis of grid search.

### CROSS-REFERENCE TO RELATED APPLICATION

This application claims priority to and the benefit of Korean Patent Application No. 2023-0157817, filed on Nov. 15, 2023, the disclosure of which is incorporated herein by reference in its entirety.

### BACKGROUND

### 1. Field of the Invention

Various embodiments of the present document relate to a knowledge graph embedding technology.

### 2. Description of Related Art

A knowledge graph represents information and knowledge in the form of a structured graph, and knowledge graph embedding is a technique for transforming a knowledge graph into a low-dimensional vector that appropriately reflects graph characteristics. Knowledge graph embedding is useful in a variety of fields, but may require high costs for processing and embedding and many resources for storing and processing. To overcome this, techniques are being disclosed that are intended to reduce a model size while ensuring that knowledge graph embedding is performed as accurately as possible even in a low-performance environment (lightweighting techniques).

Knowledge graph embedding lightweight techniques include methods involving decoding and methods not involving decoding.

A codebook-based methodology is a method involving decoding. The codebook-based methodology is a method of learning a codebook that may appropriately express existing embedding vectors and approximating an embedding vector as a combination of codebooks. According to Paper [1] (Sachan, M. 2020. Knowledge graph embedding compression. In proceedings of the 58^{th} annual meeting of the Association for Computational Linguistics, A C L 2020, Online, Jul. 5-10, 2020, 2681-2691. Association for Computational Linguistics), a codebook is generated using discrete representation learning to compress knowledge graph embedding vectors. Since discrete representation forms are not differentiable, a straight-through estimator and tempering Softmax are used to address the problem. Also, according to a lightweight knowledge graph (LightKG) (Paper [2]: Wang, H.; Wang, Y. Lian, D.; and Gao, J. 2021. A lightweight knowledge graph embedding framework for efficient inference and storage. In CIKM '21: The 30th ACM international conference on information and knowledge management, Virtual event, Queensland, Australia, Nov. 1-5, 2021, 1909-1918. ACM.), several codebooks are used for each subspace to improve accuracy, and a residual module is used to avoid learning similar codebooks.

A method of reducing a size of an embedding vector without changing a structure of the embedding vector is a method not involving decoding. In general, a methodology employing knowledge distillation is frequently used. Knowledge distillation is a technique for appropriately transferring knowledge from a teacher model with high-dimensional vectors and high accuracy to a student model with low-dimensional vectors to train the small-size model. General methodologies are MulDE (Paper [3]: Wang, K.; Liu, Y.; Ma, Q.; and Sheng, Q. Z. 2021b. MulDE: Multi-teach knowledge distillation for low-dimensional knowledge graph embeddings. In WWW '21: The web conference 2021, Virtual event/Ljubljana, Slovenia, Apr. 19-23, 2021, 1716-1726. ACM/IW3C2) and DualDE (Paper [4]: Zhu, Y.; Zhang, W.; Chen, M.; Chen, H.; Cheng, X.; Zhang, W.; and Chen, H. 2022. DualDE: Dually distilling knowledge graph embedding for faster and cheaper reasoning. In WSDM '22: The fifteenth ACM international conference on web search and data mining, Virtual event/Tempe, AZ, USA, Feb. 21-25, 2022, 1516-1524. ACM.). MulDE employs an architecture of multiple teachers and two student components (senior and junior components) to improve knowledge distillation performance in knowledge graph embedding. DualDE employs two stages. The first stage employs the same method as existing knowledge distillation, and in the second stage, a knowledge distillation architecture is changed such that a teacher model may also learn from a student model.

### RELATED ART DOCUMENTS

### Non-Patent Documents

Lee, C.: Kang, D.; and Song, H. J. 2023. Fast knowledge graph completion using graphics processing units. CoRR, abs/2307.12059.

### SUMMARY OF THE INVENTION

However, lightweight knowledge graph embedding techniques according to the related art are primarily focused on reducing model size, so there are several problems when utilizing embedding vectors in real embedded system.

For example, in the case of a first method involving decoding, it is necessary to decode encoded data in order to use an embedding vector, which requires additional space. Further, according to knowledge graph embedding of the first method, it is necessary to decode all encoded data in order to efficiently perform a repetitive task such as clustering. Here, required memory is the same as before encoding (compression), and thus there is no effect of compression.

As another example, in the case of a knowledge distillation method not involving decoding, a well-trained teacher model is required, and the knowledge distillation method itself is complex, which may complicate actual application. Also, although the number of dimensions is reduced to reduce a model size, it is necessary to perform linear scanning on all entity embedding vectors upon query processing.

As described above, general lightweight knowledge graph embedding techniques are primarily focused on reducing model size, and model accuracy, query processing time, and query processing performance are not taken into consideration.

Various embodiments disclosed in the present document are directed to providing a knowledge graph embedding device and method for lightweighting knowledge graph embedding.

According to an aspect of the present document, there is provided a device for embedding a knowledge graph, the device including an acquisition module configured to acquire a knowledge graph embedding model and a tuning module configured to generate a low-dimensional embedding model by performing hyperparameter tuning on the acquired knowledge graph embedding model on the basis of grid search.

According to another aspect of the present document, there is provided a device for embedding a knowledge graph, the device including a tuning module configured to generate a low-dimensional embedding model by performing hyperparameter tuning on a knowledge graph embedding model on the basis of grid search and a reordering module configured to reorder the low-dimensional embedding model based on a specified criterion.

According to another aspect of the present document, there is provided a method of embedding a knowledge graph, the method including acquiring a knowledge graph embedding model and generating a low-dimensional embedding model by performing hyperparameter tuning on the acquired knowledge graph embedding model on the basis of grid search.

### BRIEF DESCRIPTION OF THE DRAWINGS

The above and other objects, features and advantages of the present document will become more apparent to those of ordinary skill in the art by describing exemplary embodiments thereof in detail with reference to the accompanying drawings, in which:

FIG. 1 is a block diagram of a knowledge graph embedding device according to an exemplary embodiment;

FIG. 2 is a diagram illustrating a reordering method according to an exemplary embodiment;

FIG. 3 is a set of tables comparatively showing performance of embedding models (Ours) to which hyperparameter tuning is applied according to an exemplary embodiment, and embedding models (BKD, RKD, TA, and DualDE) according to the related art;

FIG. 4 is a set of tables comparatively showing embedding models to which hyperparameter tuning and quantization are applied according to an exemplary embodiment, and an embedding model according to the related art;

FIG. 5 is a diagram of a knowledge graph embedding device according to an exemplary embodiment;

FIG. 6 is a diagram illustrating an example of tail entity search in link prediction according to an exemplary embodiment;

FIG. 7 shows a query processing algorithm of a TransE model according to an exemplary embodiment;

FIG. 8 is a flowchart of a method of embedding a knowledge graph according to an exemplary embodiment; and

FIG. 9 is a block diagram of a computer system for implementing the method of embedding a knowledge graph according to the exemplary embodiment.

In description of the drawings, like reference numerals may be used for like components.

### DETAILED DESCRIPTION OF EXEMPLARY EMBODIMENTS

A knowledge graph represents information and knowledge in the form of a structured graph. Knowledge graph embedding is a technique for transforming a knowledge graph into a low-dimensional vector that appropriately reflects graph characteristics. Knowledge graph embedding is a data structure including entities and relations, and a knowledge graph may provide a structured representation of knowledge. A knowledge graph embedding model may include at least one of a TransE model, a SimplE model, a ComplEx model, and a RotatE model.

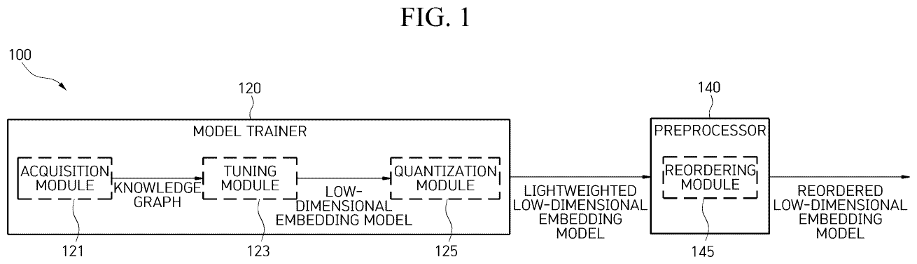

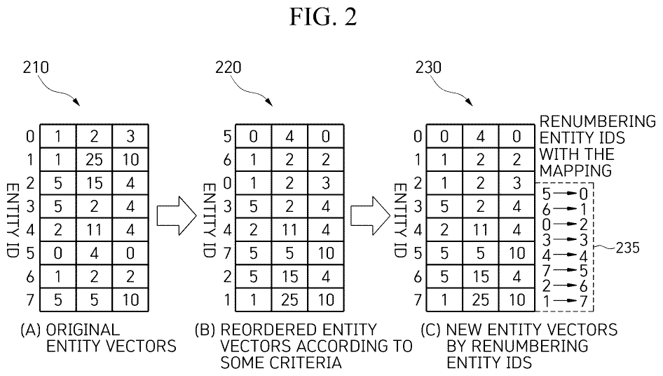

FIG. 1 is a block diagram of a knowledge graph embedding device according to an exemplary embodiment. FIG. 2 is a diagram illustrating a reordering method according to an exemplary embodiment.

Referring to FIG. 1, a knowledge graph embedding device 100 according to an exemplary embodiment may include a model trainer 120 and a preprocessor 140. The model trainer 120 and the preprocessor 140 may include at least one processor or may be a software module that is executed by a processor.

According to an exemplary embodiment, the model trainer 120 may acquire a knowledge graph and reduce dimensions of the acquired knowledge graph to generate a low-dimensional embedding model. For example, the model trainer 120 may reduce dimensions of a knowledge graph through at least one operation of hyperparameter tuning and quantization.

According to an exemplary embodiment, the model trainer 120 may include an acquisition module 121, a tuning module 123, and a quantization module 125. At least one of the acquisition module 121, the tuning module 123, and the quantization module 125 may be included in another module or omitted. For example, the acquisition module 121 and the tuning module 123 may be integrated into one module. As another example, the model trainer 120 may include the acquisition module 121 and the tuning module 123 and not include the quantization module 125.

According to an exemplary embodiment, the tuning module 123 may acquire a knowledge graph as an input and perform hyperparameter tuning on the acquired knowledge graph on the basis of grid search. The tuning module 123 may generate a low-dimensional embedding model by reducing dimensions of an embedding vector through hyperparameter tuning based on grid search.

According to an exemplary embodiment, the quantization module 125 may acquire the embedding model of which dimensions are reduced by the tuning module 123 and lightweight the embedding model (e.g., reduce a size of the embedding model) by quantizing entity embedding vectors of the acquired embedding model. In this regard, entity embedding vectors are vectors representing entities and may be used for representing entities extracted from text in values.

The quantization module 125 may lightweight an embedding model in different ways depending on the type of embedding model. For example, as shown in Expression 1, the quantization module 125 may apply a different quantization Expression to an entity embedding vector e depending on which one of a TransE model, a SimplE model, a ComplEx model, and a RotatE model the embedding model is. In the case of the TransE model, the quantization module 125 may divide a relation embedding (relation type) vector by qₜ to maintain its attributes.

$$TransE : {e}^{′} [ i ] = {Q}_{B , {M}_{1} , {M}_{2}} ( e [ i ] ) , {r}^{′} [ i ] = r [ i ] / {q}_{t} for all i \\ SimplE : {e}^{′} [ i ] = {Q}_{B , {M}_{1} , {M}_{2}}^{′} ( e [ i ] ) , {r}^{′} [ i ] = r [ i ] for all i \\ ComplEx : {e}^{′} [ i ] = {Q}_{B , {M}_{1} , {M}_{2}}^{′} ( e [ i ] ) , {r}^{′} [ i ] = r [ i ] for all i \\ RotatE : {e}^{′} [ i ] = {Q}_{B , {M}_{1} , {M}_{2}}^{′} ( e [ i ] ) , {r}^{′} [ i ] = r [ i ] for all i \qquad [ Expression 1 ]$$

In Expression 1, Q is as shown in Expression 2, and Q′ may be calculated as shown in Expression 3 below.

$${Q}_{B , {M}_{1} , {M}_{2}} ( x ) = round ( \frac{x}{{q}_{t}} ) - round ( \frac{{M}_{1}}{{q}_{t}} ) \qquad [ Expression 2 ]$$

$${Q}_{B , {M}_{1} , {M}_{2}}^{′} ( x ) = round ( \frac{x}{{q}_{t}} ) \qquad [ Expression 3 ]$$

In Expressions 1 to 3 above, B may be the number of bits for storing one piece of data of an entity embedding vector, M₁ may be the smallest value among elements of entity embedding vectors, M₂ may be the largest value among the elements of the entity embedding vectors, and the “round” function may be a function of rounding off at the first decimal place. qₜ is a quantization size and may be calculated in accordance with Expression 4 below. For example, a float number stores 4-byte (32 bits) data. In order to reduce the float number to 1 byte through, B may be set to 8 and a quantization size may be calculated in accordance with Expression 4 below.

$${q}_{t} = \frac{{M}_{2} - {M}_{1}}{{2}^{B} - 1} \qquad [ Expression 4 ]$$

According to an exemplary embodiment, the preprocessor 140 may include a reordering module 145. The reordering module 145 may acquire the lightweighted embedding model as an input and reorder the entity embedding vectors of the acquired embedding model based on a specified criterion (e.g., score).

For example, when the reordering module 145 reorders the TransE model, the criterion for reordering entity vectors may be calculated as shown in Expression 5 below. The specified criterion may include, for example, one of an L1 norm (Manhattan distance) and an L2 norm (Euclidean distance). In Expression 5 below, a pivot vector “p” may be a vector representing a reference point or center point in a multidimensional space. In this document, for convenience of description, a case where the reordering module 145 reorders the TransE model will be described. However, it is not limited thereto.

$$dist ( e , p ) = {‖ e - p ‖}_{L 1 / L 2} \qquad [ Expression 5 ]$$

For an entity embedding vector e, the reordering module 145 may calculate the L1 norm (Manhattan distance) as shown in Expression 6 below or calculate the L2 norm (Euclidean distance) as shown in Expression 7 below.

$${‖ e - p ‖}_{L 1} = {\sum }_{i} \vert e [ i ] - p [ i ] \vert \qquad [ Expression 6 ]$$

As shown in Expression 6 above, a Manhattan distance may be calculated by adding all absolute values of differences between the embedding vectors and a pivot vector.

$${‖ e - p ‖}_{L 2} = s q rt ( {\sum }_{i} {( e [ i ] - p [ i ] )}^{2} ) \qquad [ Expression 7 ]$$

As shown in Expression 7 above, a Euclidean distance may be calculated as a square root of a sum of squares of differences between elements of the embedding vectors and a pivot vector.

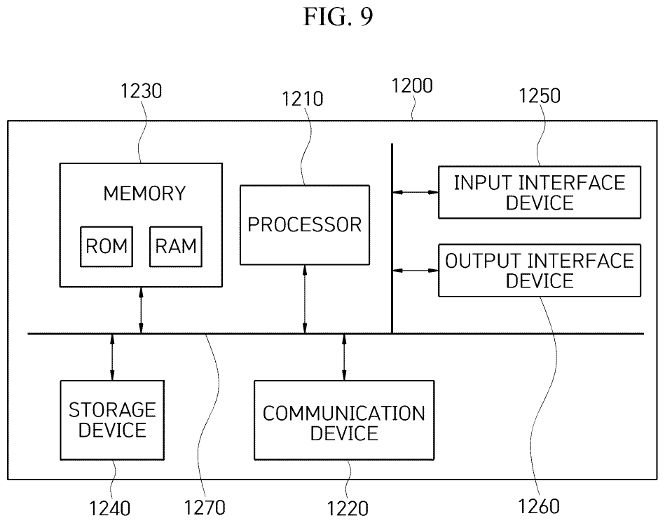

Referring to FIG. 2, the reordering module 145 may acquire entity embedding vectors (lightweighted low-dimensional entity embedding vectors) in operation 210. In operation 220, the reordering module 145 may reorder the entity embedding vectors according to a specified criterion of Manhattan distance or Euclidean distance. In operation 230, the reordering module 145 may give new entity identifiers (IDs) by renumbering the reordered entity embedding vectors. After operation 230, mapping information (5→0, 6→1, . . . ) 235 between previous entity IDs and the new entity IDs is unnecessary. Accordingly, the reordering module 145 may store the mapping information in a memory 1230 (see FIG. 9) during renumbering and delete the mapping information from the memory 1230 after renumbering is completed.

According to an exemplary embodiment, the reordering module 145 may perform reordering using various methods. For example, the reordering module 145 may utilize a space-filling curve algorithm to number multidimensional data into one-dimensional values such that their localities may be maintained. However, the present document is not limited thereto.

For example, the TransE model which is a knowledge graph embedding model may be used for learning relations between objects. The TransE model considers an entity one point in a coordinate space and expresses a relation in a graph using the concept of translation in the coordinate space. In other words, when one piece of triple data (head, relation, and object) is given, an embedding vector is learned such that a sum of a head embedding vector and a relation embedding vector may equal a tail embedding vector (head embedding vector+relation embedding vector=tail embedding vector).

A score function S (h, r, t) of the TransE model is defined as shown in Expression 8 below to calculate a score for a given triple. h may be an embedding vector of a given triple head object, r may be an embedding vector of a triple relation object, and t may be an embedding vector of a triple tail object. A triple with a lower score may be more appropriate. The TransE model may consider a relation a calculation of moving an entity in an embedding space to evaluate and learn the triple. The TransE model is frequently used in knowledge graph expression learning and may be appropriate for relation inference and inter-object relation learning.

$$S ( h , r , t ) = {‖ h + r - t ‖}_{L 1 or L 2} \\ ( L 1 is an L 1 norm and L 2 is an L 2 norm ) \qquad [ Expression 8 ]$$

In this case, the reordering module 145 may sort the entity embedding vectors of the TransE model in increasing order of score on the basis of difference values between the embedding vectors and a pivot vector.

According to various embodiments, the knowledge graph embedding device 100 may not have at least one of the acquisition module 121, the tuning module 123, the quantization module 125, and the reordering module 145. For example, the knowledge graph embedding device 100 may only include the acquisition module 121 and the tuning module 123 or only include the tuning module 123 and the reordering module 145. However, the knowledge graph embedding device 100 is not limited thereto.

As described above, the knowledge graph embedding device 100 according to an exemplary embodiment does not involve decoding, and thus it is possible to provide a knowledge graph embedding model size reduction technique for reducing storage space.

In addition, the knowledge graph embedding device 100 according to an exemplary embodiment performs score-based reordering on an embedding model, and thus it is possible to avoid linearly searching all entities for querying and answering.

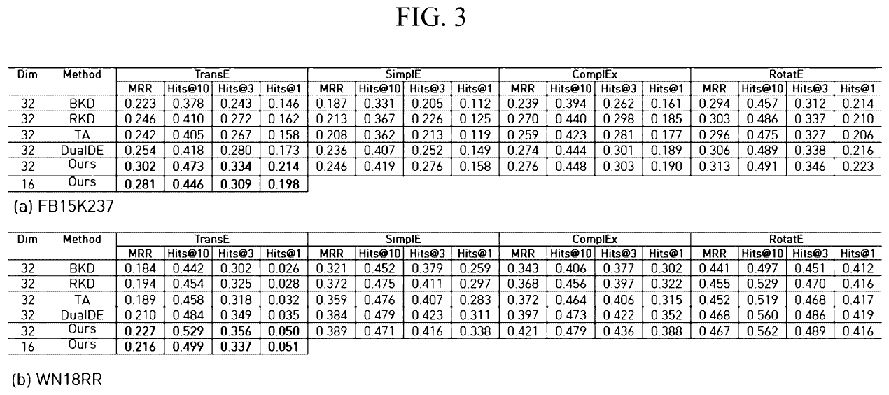

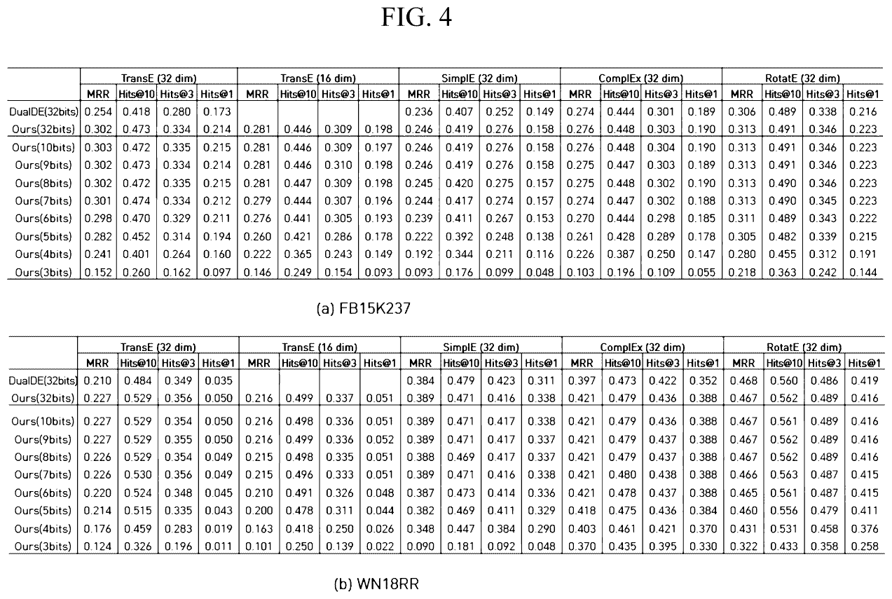

Performance of a knowledge graph embedding method according to an exemplary embodiment will be described below with reference to FIGS. 3 and 4.

FIG. 3 is a set of tables comparatively showing performance of embedding models (Ours) to which hyperparameter tuning is applied according to an exemplary embodiment, and embedding models (BKD, RKD, TA, and DualDE) according to the related art. Specifically, when a low-dimensional embedding model is directly trained for lightweighting, the trained embedding model may show low accuracy. To prevent this, a lightweighted embedding model with higher accuracy can be acquired by applying a knowledge distillation technique for extracting various forms of knowledge from a previously built high-dimensional neural network (a teacher network; teacher), to train a low-dimensional neural network (a student network; student).

In FIG. 3, all of BKD, RKD, TA, and DualDE may show performance data of lightweighted knowledge graph embedding models using knowledge distillation methods. BKD, RKD, and TA may be methods that are applicable to general neural networks irrespective of knowledge graph embedding, and DualDE may be a knowledge distillation technique specialized in knowledge graph embedding. BKD is a basic knowledge distillation technique. RKD may be a technique for extracting knowledge from a high-dimensional neural network using a structural difference. TA may be a method of performing knowledge distillation using a medium-scale network that may connect a high-dimensional neural network to a low-dimensional neural network. DualDE may be a learning model that provides a knowledge distillation architecture for providing a recurrent structure in which knowledge may be not only transferred from a teacher network to a student network but also transferred from a student network to a teacher network. In FIG. 3, FB15K237 and WN18RR are the names of datasets respectively used for evaluating and training a knowledge graph embedding model, and DIM is the number of vector dimensions. Each of mean reciprocal rank (MRR) and hyperlink-induced topic search (HITS)@10 is an information retrieval performance evaluation indicator and is better when closer to 1. MRR may be used for measuring how accurate results are found in accordance with the ranking of search results. HITS@x (e.g. HITS@10) may be a value for evaluating the performance of a search task and representing how effective the search task is in finding an accurate result from among top x (e.g., 5) search results.

FIG. 3 shows that the knowledge graph embedding device 100 according to an exemplary embodiment employing only the tuning module 123, which performs hyperparameter tuning on the basis of grid search, can provide more accurate search results than knowledge graph embedding models based on knowledge distillation according to the related art.

As described above, the tuning module 123 according to an exemplary embodiment employs not only a knowledge graph embedding model lightweighting technique not involving decoding but also hyperparameter tuning which shows lower calculation and implementation complexity than knowledge distillation, making it possible to provide a knowledge graph embedding model with better retrieval performance.

FIG. 4 is a set of tables showing performance of embedding models to which hyperparameter tuning and quantization are applied according to an exemplary embodiment, and an embedding model according to the related art.

In FIG. 4, MRR, HITS@10, HITS@3, and HITS@1 values were measured using embedding models (e.g., Ours (32 bits)) of which sizes were reduced with different numbers B of quantization bits of the quantization module 125, and an embedding model that was lightweighted using a DualDE technique according to the related art.

As shown in FIG. 4, when the model trainer 120 according to an exemplary embodiment implements a 32-bit embedding model which is the same as an embedding model lightweighted using the DualDE technique, it is possible to provide better performance. When the number of quantization bits is 7 or more, the performance can be kept at a certain level, and when the number of quantization bits is 6 or less, it is possible to provide a similar level of performance to the related art.

As described above, even when a size of a knowledge graph embedding model is reduced to about ⅕ or less, the model trainer 120 according to an exemplary embodiment can ensure the retrieval performance somewhat stably. Accordingly, the knowledge graph embedding device 100 according to an exemplary embodiment can overcome degradation of the retrieval performance based on a knowledge graph to some extent even after lightweighting.

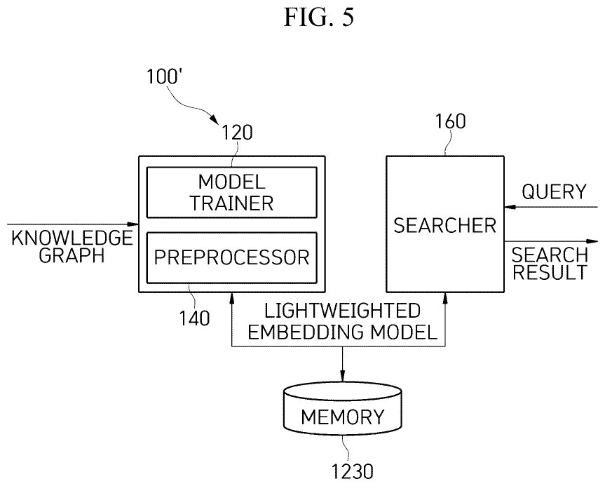

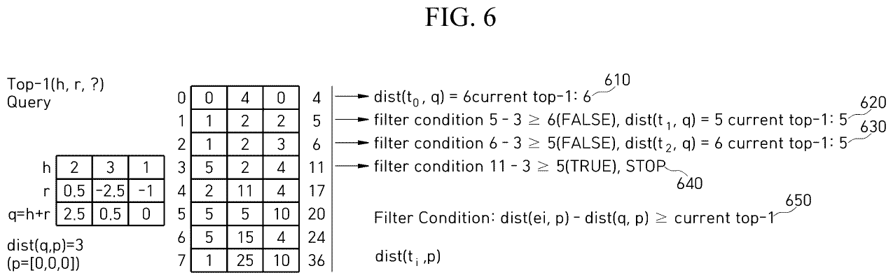

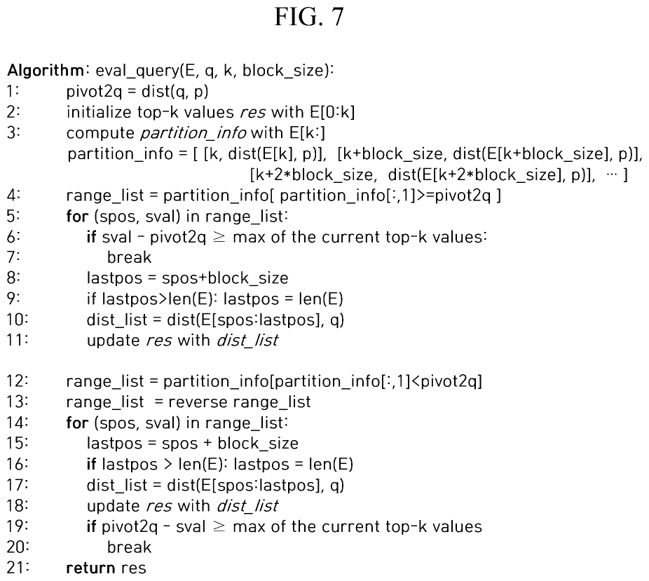

FIG. 5 is a diagram of a knowledge graph embedding device according to an exemplary embodiment, and FIG. 6 is a diagram illustrating an example of tail entity search in link prediction according to an exemplary embodiment. FIG. 7 shows a query processing algorithm of a TransE model according to an exemplary embodiment.

Referring to FIG. 5, a knowledge graph embedding device 100′ may include a model trainer 120, a preprocessor 140, and a searcher 160. The knowledge graph embedding device 100′ and the searcher 160 may be included in at least one processor or may be software modules that are executed by at least one processor. Since the model trainer 120 and the preprocessor 140 have been described above, the searcher 160 will be mainly described in FIG. 5.

According to an exemplary embodiment, when a query is acquired, the searcher 160 may search for at least one entity corresponding to the query using a lightweighted embedding model and provide the searched entity. The acquired query may include, for example, similar entity search, head entity search in link prediction, or tail entity search in link prediction.

Similar entity search may be a task of searching for entities with similar characteristics or relations to a query entity. A similar entity search query is a basic query in knowledge graph embedding. In the case of similar entity search, the searcher 160 measures similarities between entities in a knowledge graph and searches k entities in a conceptually similar order.

Head or tail entity search in link prediction is a task of searching for an entity connected to a given entity in accordance with the given entity and a given relation, and a head or tail entity in a specific relation may be searched for. This may be used for finding a specific connection on the basis of link prediction and a structure of a knowledge graph. When a head or tail entity vector and a relation vector are given, the searcher 160 may search for an entity having the smallest score between the head or tail entity vector and the relation vector in accordance with a query.

For convenience of description, kinds of queries will be described in terms of word embedding. For example, word embedding vectors of similar words may be positioned close to each other in a vector space. In other words, “King” and “Queen” may exist close to each other in a vector space.
King=[0, 0, 1]
Queen=[0, 0, 1.1]
Sports=[10, 2, 0]

In the case of similar entity search, a query involves searching for K similar words to “King,” and thus k values are searched for in increasing order of dist (distance) (King, WORD). On the other hand, a head entity search query in link prediction may involve simultaneously inputting the entity “King” and the relation “isFatherOf.” In this case, a value of the smallest score is searched for that is highly likely to be connected to the entity “King” by the relation “isFatherOf”. In other words, a head entity search query in link prediction may be a query for finding a similar entity in consideration of a relation as well as the entity. According to an exemplary embodiment, the searcher 160 performs search not for word embedding but for knowledge graph embedding. However, like in word embedding, a query may be replaced to search for an entity corresponding to the query. This will be described below.

According to an exemplary embodiment, the searcher 160 may specify q differently depending on a type of query. In the case of similar entity search, “q=e” (e is an entity embedding vector) may be set. In the case of tail entity search in link prediction, “q=h+r” (h is a head embedding vector, and r is a relation embedding vector) may be set. In the case of head entity search in link prediction, “q=t−r” (t is a tail embedding vector) may be set. In addition, similar entity search may be searching for k eᵢ in increasing order of dist(eᵢ, q) (eᵢ: an embedding vector, and q: a query). Tail entity search in link prediction may be searching for, when queries h and r are given, k eᵢ in increasing order of score (h, r, eᵢ)=dist(h+r, eᵢ)=dist(eᵢ, h+r). In the case of head entity search in link prediction, “score (eᵢ, r, t)=∥eᵢ+r−t∥=∥−(−eᵢ−r+t)∥=∥ (−eᵢ−r+t)∥=∥ (t−r)−eᵢ∥=dist(t−r, eᵢ)−dist(eᵢ, t−r)” holds, and thus it may be considered as “q=t−r.” Similarly, in the case of head entity search, q=h+r may be set, and the criterion may be converted into the form of dist(q, e) and then taken into consideration.

To determine a search result corresponding to an acquired query, the searcher 160 may calculate a distance (∥q−e∥_{L1/L2}) between the query and each entity embedding vector e and provide k entities in increasing order of distance.

According to an exemplary embodiment, the searcher 160 may determine a filter condition in a metric space using a lemma as shown in Expression 9 below.

$$dist ( {e}_{i} , q ) \geq dist ( {e}_{i} , p ) - dist ( q , p ) \qquad [ Expression 9 ]$$

The searcher 160 may determine a different filter condition depending on whether Expression 10 determined based on Expression 9 is satisfied.

$$dist ( {e}_{i} , p ) \geq dist ( q , p ) \qquad [ Expression 10 ]$$

When Expression 10 is satisfied, Expression 11 below may be calculated as a filter condition.

$$dist ( {e}_{i} , p ) - dist ( q , p ) \geq maximum of current top - k values \qquad [ Expression 11 ]$$

In Expression 11 above, dist(q, p) is a fixed value, and entity embedding vectors are ordered by the reordering module 145 on the basis of dist(eᵢ, p). Accordingly, in an embedding model according to an exemplary embodiment, a dist(eᵢ, p)−dist(q, p) value increases with an increase of i. Therefore, when “dist(eᵢ, p)−dist(q, p)≥maximum of current top-k values” is satisfied at a time point of i, a “dist(eⱼ, q)” value of an entity embedding vector after the time point of i does not decrease any more. Consequently, it is unnecessary to additionally check any entity embedding vector, and the searcher 160 may stop the entity scan. The maximum of the current top-k values is the largest one of the current top-k values (i.e., top-10 is the tenth value in increasing order) and may decrease along with an increase of i.

As described above, the searcher 160 according to an exemplary embodiment can process a query without having to sequentially scan all entity embedding vectors.

In FIG. 6, an acquired query may be a query requesting a top-1 search result of tail entity search in link prediction. Also, values of a head embedding vector related to the query are (2, 3, 1), and values of a relation embedding vector are (0.5, −2.5, −1). A pivot vector may be set as a zero vector, and k may be set to 1. A case where a criterion for ordering (specified criterion) of the reordering module 145 is dist(e, p)=∥e−p∥₁ will be described.

Referring to FIG. 6, the searcher 160 may check that the query is tail entity search in link prediction and calculate a query of q as h+r, that is, (2.5, 0.5, 0). Since the query is a top-1 query requesting a top-1 search result, this may be the same as a process of calculating min_{e∈E}∥q−e∥ (E is an entity embedding vector set).

In operation 610, the searcher 160 calculates∥e₀−q∥ for e₀, that is, dist(e₀, q). The searcher 160 may calculate dist(e₀, q) (dist(e₀, q)=6) and update a current top-1 result with “6.” In the present document, eᵢ is considered the same as tᵢ.

In operation 620, the searcher 160 may check a filter condition (filtering condition) beginning with a second entity embedding vector. For example, since dist(e₀, p)=5 and dist(q, p)=3, a filter condition (5−3≥6) is not satisfied. Since dist(q, p) is a fixed value, a calculated value may be stored once, and the stored value may be used thereafter. In the case of e₁ (i.e., t₁), the filter condition is not satisfied. Accordingly, dist(e₁, q) may be calculated, and the current top-1 result may be updated with 5.

In operation 630, a similar operation to operation 620 may also be performed for the third entity embedding vector e₂.

In operation 640, in the case of the fourth entity embedding vector e₃, the filter condition of Expression 11 is satisfied, and thus the scan may be stopped. In other words, in the case of the fourth entity embedding vector, 11−3≥top-1 value (i.e., 5) among the current top-k values is satisfied, and thus the scan is stopped. Since the embedding vectors are ordered in order of dist(eᵢ, p) which increases with an increase in the entity turn, there is no value smaller than a top-1 value of the current top-k values.

When Expression 10 is not satisfied, the searcher 160 may search for a result corresponding to the query under a filter condition of Expression 12 below. This will be described in detail below with reference to FIG. 7.

$$dist ( q , p ) - dist ( {e}_{i} , p ) \geq maximum of current top - k values \qquad [ Expression 12 ]$$

Referring to FIG. 7, for efficiency in calculation, the searcher 160 may calculate a distance between the query and an embedding vector in units of block size. When the searcher 160 is a graphics processing unit (GPU), distance calculation between a plurality of embedding vectors may be processed in parallel, and thus the distances may be calculated in units of block size.
In line 1, the searcher 160 may calculate a distance dist(q, p) from the pivot vector to a query vector q.
In line 2, the searcher 160 may initialize the variable “res” for storing top-k results. Here, res may be initialized using k vectors in front of an entity embedding vector E. The variable “res” may be provided in a two-dimensional (2D) array with a size of k×2 to simultaneously store top-k values and positions of the top-k values and thus.
In line 3, the searcher 160 may generate virtual partitions for data of E[k:] in units of block size and calculate dist(E[i], p) for the first element of each partition. After line 3, a loop of case 1 (lines 4 to 44) or case 2 (lines 12 to 20) may be performed on the basis of the partition information.
Case 1 is a case where dist(eᵢ, p)≥dist(q, p) and corresponds to lines 4 to 11 in the algorithm. A partition corresponding to case 1 is calculated using the expression of line 4. The foregoing filter condition is checked in line 6. In other words, when sval−pivot2q≥max of current top-k values, the filter condition is satisfied, and the scan is stopped. sval is a value corresponding to dist(E[i], p).
Case 2 is a case where dist(eᵢ, p)<dist(q, p) and corresponds to lines 12 to 20 in the algorithm. A partition corresponding to case 2 is calculated using the expression of line 12. Here, the filter condition is dist(q, p)−dist(eᵢ, p)≥maximum of current top-k values. In contrast with case 1, dist(q, p)−dist(eᵢ, p) decreases with an increase of i, and thus the order of partitions to be checked is reversed in line 13. The foregoing filter condition is checked in line 19. In other words, when pivot2q−val≥max of current top-k values is satisfied, the scan is stopped.

As described above, the knowledge graph embedding device 100′ according to an exemplary embodiment can provide a framework that does not require decoding but can avoid linear scan of all entities upon query processing.

Also, the knowledge graph embedding device 100′ according to an exemplary embodiment not only provides a framework actually applicable to an embedded environment but can also improve all of search accuracy, storage space, and query processing time.

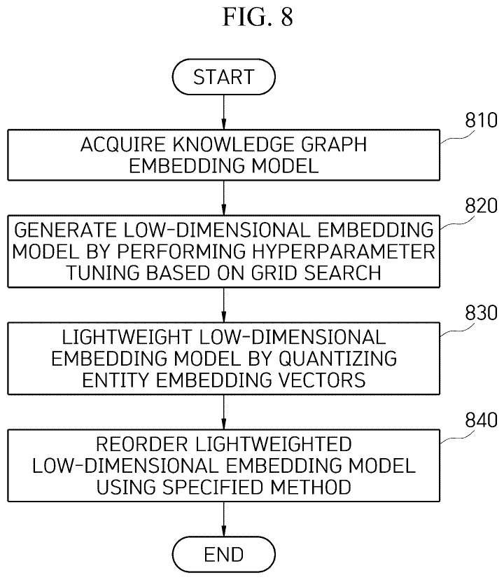

FIG. 8 is a flowchart of a method of embedding a knowledge graph according to an exemplary embodiment.

In operation 810, the knowledge graph embedding device 100 may acquire a knowledge graph embedding model.

In operation 820, the knowledge graph embedding device 100 may generate a low-dimensional embedding model by performing hyperparameter tuning on the acquired knowledge graph embedding model on the basis of grid search.

In operation 830, the knowledge graph embedding device 100 may reduce a size of the low-dimensional embedding model by quantizing entity embedding vectors of the low-dimensional embedding model in a specified size of qₜ calculated using Expression 4 above. In operation 830, when the knowledge graph embedding model is a TransE model, entity embedding vectors of the TransE model may be quantized using the following expression:

$${Q}_{B , {M}_{1} , {M}_{2}} ( x ) = round ( \frac{x}{{q}_{i}} ) - round ( \frac{{M}_{1}}{{q}_{t}} ) .$$

Here, round(y) is a function of rounding a value of y off at the first decimal place, and relation embedding vectors of the TransE model may be divided in the quantization size of the entity embedding vectors. Alternatively, when the knowledge graph embedding model is a SimplE model, a ComplEx model, or a RotatE model, the knowledge graph embedding device 100 may quantize entity embedding vectors of the embedding model using the following expression:

$${Q}_{B , {M}_{1} , {M}_{2}}^{′} ( x ) = round ( \frac{x}{{q}_{i}} ) .$$

In operation 840, the knowledge graph embedding device 100 may reorder the lightweighted low-dimensional embedding model using a specified method. For example, the knowledge graph embedding device 100 may calculate similarities between the lightweighted low-dimensional embedding model and a pivot vector and order the lightweighted low-dimensional embedding model in order of the calculated similarities.

Subsequently, when a query is acquired, the knowledge graph embedding device 100 may acquire a search result corresponding to the query on the basis of similarities between the acquired query and the lightweighted low-dimensional embedding model.

FIG. 9 is a block diagram of a computer system for implementing the method of embedding a knowledge graph according to the exemplary embodiment of the present invention.

Referring to FIG. 9, a computer system 1200 (e.g., the knowledge graph embedding device 100 of FIG. 1 or the knowledge graph embedding device 100′ of FIG. 5) may include at least one of a processor 1210, the memory 1230, an input interface device 1250, an output interface device 1260, and a storage device 1240 that communicate via a bus 1270. The computer system 1200 may further include a communication device 1220 connected to a network. The processor 1210 may be a central processing unit (CPU) or a semiconductor device that executes instructions stored in the memory 1230 or the storage device 1240. The memory 1230 and the storage device 1240 may include various kinds of volatile or non-volatile storage media. For example, the memory 1230 may include a read-only memory (ROM) and a random access memory (RAM). In an exemplary embodiment of the present disclosure, a memory may be in or outside a processor and connected to the processor via various known devices. The processor 1210 may control at least one other component (e.g., a hardware or software component) of the computer system 1200 and perform various data processes or calculations. For example, the processor 1210 may include at least one of a CPU, a GPU, a microprocessor, an application processor, an application-specific integrated circuit (ASIC), and a field programmable gate array (FPGA), and may have a plurality of cores. The processor 1210 may include or execute at least one component among the tuning module 123, the acquisition module 121, the reordering module 145, and the searcher 160.

Various embodiments of the present document and terms used therein are not intended to limit technical characteristics described in the present document to specific embodiments, and it should be understood that the present document includes various modifications, equivalents, or substitutions of the embodiments. In description of drawings, similar reference numerals may be used for similar or associated components. A singular form of a noun corresponding to an item may include one or more items unless the context clearly indicates otherwise. In the present document, expressions such as “A or B,” “at least one of A and B,” “at least one of A or B,” “A, B, or C,” “at least one of A, B, and C” and “at least one of A, B, or C” may include any one of or all possible combinations of items listed together in a corresponding one of the expressions. Terms such as “1^{st},” “2^{nd},” “first,” “second,” and the like may be used to simply distinguish a corresponding component from another, and do not limit the components in another aspect (e.g., importance or order). When a certain (e.g., first) component is referred to, with or without the term “functionally” or “communicatively,” as “coupled” or “connected” to another (e.g., second) component, it means that the certain component may be coupled with the other component directly (e.g., by wire), wirelessly, or via a third component.

As used herein, the term “module” may include a unit implemented in hardware, software, or firmware and may interchangeably be used with other terms, for example, “logic,” “logic block,” “part,” or “circuit.” A module may be a single integral component or a minimum unit or part thereof that performs one or more functions. For example, according to an embodiment, a module may be implemented in the form of an ASIC.

Various embodiments of the present document may be implemented as software (e.g., a program) including one or more instructions that are stored in the storage medium 1230 (e.g., an internal memory or an external memory) that is readable by a machine (e.g., an electronic device). For example, a processor (e.g., the processor 1210) of a device (e.g., the computer system 1200) may invoke at least one of the one or more stored instructions from the storage medium and execute the at least one invoked instruction. This allows the machine to be operated to perform at least one function in accordance with the at least one invoked instruction. The one or more instructions may include code generated by a compiler or code executable by an interpreter. The machine-readable storage medium may be provided in the form of a non-transitory storage medium. Here, the term “non-transitory” simply means that the storage medium is a tangible device and does not include a signal (e.g., an electromagnetic wave), but this term does not distinguish between a case where data is semi-permanently stored in the storage medium and a case where data is temporarily stored in the storage medium.

According to various embodiments disclosed in the present document, it is possible to lightweight knowledge graph embedding. In addition, it is possible to provide various effects that are directly or indirectly identified in the present document.

According to an embodiment, methods according to various embodiments set forth herein may be included and provided in a computer program product. The computer program product may be traded as a product between a seller and buyer. The computer program product may be distributed in the form of a machine-readable storage medium (e.g., a compact disc (CD)-ROM) or distributed (e.g., downloaded or uploaded) online via an application store (e.g., PlayStore™) or between two user devices (e.g., smartphones) directly. When distributed online, at least a part of the computer program product may be temporarily generated or at least temporarily stored in the machine-readable storage medium such as a memory of the manufacturer's server, an application store server, or a relay server.

Components according to various embodiments of the present document may be implemented in the form of software or hardware, such as a digital signal processor (DSP), an FPGA, or an ASIC, and perform predetermined roles. The term “components” is not limited to software or hardware, and each component may be configured to be in an addressable storage medium or to operate one or more processors. Examples of components may include software components, object-oriented software components, class components, task components, processes, functions, attributes, procedure, subroutines, segments of program code, drivers, firmware, microcode, circuits, data, databases, data structures, tables, arrays, and variables.

According to various embodiments, each (e.g., a module or a program) of the foregoing components may include a single entity or multiple entities. According to various embodiments, one or more of the foregoing components or operations may be omitted, or one or more other components or operations may be added. Alternatively, or additionally, a plurality of components (e.g., modules or programs) may be integrated into a single component. In such a case, the integrated component may still perform one or more functions of each of the plurality of components in the same or similar manner as they are performed by a corresponding one of the plurality of components before the integration. According to various embodiments, operations performed by a module, a program, or another component may be carried out sequentially, in parallel, repeatedly, or heuristically, or one or more of the operations may be executed in a different order or omitted, or one or more other operations may be added.

What is claimed is:

1. A device for embedding a knowledge graph, the device comprising:
an acquisition module configured to acquire a knowledge graph embedding model; and
a tuning module configured to generate a low-dimensional embedding model by performing hyperparameter tuning on the acquired knowledge graph embedding model on the basis of grid search.

2. The device of claim 1, further comprising a quantization module configured to lightweight the low-dimensional embedding model by quantizing entity embedding vectors of the low-dimensional embedding model.

3. The device of claim 2, wherein the quantization module performs quantization in a specified size of qₜ that is calculated using the following expression:
$${q}_{t} = \frac{{M}_{2} - {M}_{1}}{{2}^{B} - 1}$$
where B is a number of bits for storing one piece of data of an entity embedding vector, M₁ is a smallest value among elements of the entity embedding vectors, and M₂ is a largest value among the elements of the entity embedding vectors.

4. The device of claim 3, wherein, when the knowledge graph embedding model is a TransE model, the quantization module quantizes the entity embedding vectors of the TransE model using the following expression:
$${Q}_{B , {M}_{1} , {M}_{2}} ( x ) = round ( \frac{x}{{q}_{i}} ) - round ( \frac{{M}_{1}}{{q}_{t}} )$$
where round(y) is a function of rounding a value of y off at a first decimal place, and
the quantization module divides relation embedding vectors of the TransE model into a quantization size of the entity embedding vectors.

5. The device of claim 3, wherein, when the knowledge graph embedding model is a SimplE model, a ComplEx model, or a RotatE model, the quantization module quantizes entity embedding vectors of the embedding model using the following expression:
$${Q}_{B , {M}_{1} , {M}_{2}}^{′} ( x ) = round ( \frac{x}{{q}_{i}} )$$
where round(y) is a function of rounding a value of y off at a first decimal place.

6. The device of claim 2, further comprising a reordering module configured to reorder the lightweighted low-dimensional embedding model based on a specified criterion.

7. The device of claim 6, wherein the reordering module calculates similarities between the lightweighted low-dimensional embedding model and a pivot vector and orders the lightweighted low-dimensional embedding model in order of the calculated similarities.

8. The device of claim 6, further comprising a searcher configured to acquire a search result corresponding to a query from the lightweighted low-dimensional embedding model.

9. The device of claim 8, wherein, when a first similarity distance between each of the entity embedding vectors and a pivot table is larger than or equal to a second similarity distance between the query and the pivot table, the searcher determines an entity embedding vector for which a difference obtained by subtracting the second similarity distance from the first similarity distance is a maximum of current top-k values as the search result corresponding to the query among the entity embedding vectors.

10. The device of claim 8, wherein, when a first similarity distance between each of the entity embedding vectors and a pivot table is smaller than a second similarity distance between the query and the pivot table, the searcher determines an entity embedding vector for which a difference obtained by subtracting the first similarity distance from the second similarity distance is a maximum of current top-k values as the search result corresponding to the query among the entity embedding vectors.

11. A device for embedding a knowledge graph, the device comprising:
a tuning module configured to generate a low-dimensional embedding model by performing hyperparameter tuning on a knowledge graph embedding model on the basis of grid search; and
a reordering module configured to reorder the low-dimensional embedding model based on a specified criterion.

12. The device of claim 11, wherein the reordering module calculates similarities between the low-dimensional embedding model and a pivot vector and orders the lightweighted low-dimensional embedding model in order of the calculated similarities.

13. The device of claim 11, further comprising a quantization module configured to lightweight the low-dimensional embedding model by quantizing entity embedding vectors of the low-dimensional embedding model.

14. The device of claim 11, further comprising a searcher configured to acquire, when a query is acquired, a search result corresponding to the query on the basis of similarities between the query and the low-dimensional embedding model.

15. A method of embedding a knowledge graph, the method comprising:
acquiring a knowledge graph embedding model; and
generating a low-dimensional embedding model by performing hyperparameter tuning on the acquired knowledge graph embedding model on the basis of grid search.

16. The method of claim 15, comprising lightweighting the low-dimensional embedding model by quantizing entity embedding vectors of the low-dimensional embedding model in a specified size of qₜ that is calculated using the following expression:
$${q}_{t} = \frac{{M}_{2} - {M}_{1}}{{2}^{B} - 1}$$
where B is a number of bits for storing one piece of data of an entity embedding vector, M₁ is a smallest value among elements of the entity embedding vectors, and M₂ is a largest value among the elements of the entity embedding vectors.

17. The method of claim 16, wherein the lightweighting of the low-dimensional embedding model comprises:
when the knowledge graph embedding model is a TransE model, quantizing the entity embedding vectors of the TransE model using the following expression:
$${Q}_{B , {M}_{1} , {M}_{2}} ( x ) = round ( \frac{x}{{q}_{i}} ) - round ( \frac{{M}_{1}}{{q}_{t}} )$$
where round(y) is a function of rounding a value of y off at a first decimal place; and
dividing relation embedding vectors of the TransE model into a quantization size of the entity embedding vectors.

18. The method of claim 16, wherein the lightweighting of the low-dimensional embedding model comprises:
when the knowledge graph embedding model is a SimplE model, a ComplEx model, or a RotatE model, quantizing entity embedding vectors of the embedding model using the following expression:
$${Q}_{B , {M}_{1} , {M}_{2}}^{′} ( x ) = round ( \frac{x}{{q}_{i}} )$$
where round(y) is a function of rounding a value of y off at a first decimal place.

19. The method of claim 16, further comprising:
calculating similarities between the lightweighted low-dimensional embedding model and a pivot vector; and
ordering the lightweighted low-dimensional embedding model in order of the calculated similarities.

20. The method of claim 16, further comprising acquiring a search result corresponding to a query on the basis of similarities between the query and the lightweighted low-dimensional embedding model.
